(19) United States
(12) Patent Application Publication
(10) Pub. No.: US 2011/0308104 A1
(43) Pub. Date: Dec. 22, 2011

(54) GREEN CUBE CLOTH DRYER

(76) Inventor: Gurdeep Singh, Sterling, VA (US)

(21) Appl. No.: 12/819,258

(22) Filed: Jun. 21, 2010

(51) Int. Cl. F26B 3/02; F26B 25/18; F26B 25/06

(52) U.S. Cl. 34/518; 34/218; 34/239

(57) ABSTRACT

Exemplary embodiments describe a clothes drying apparatus and a method for using a clothes drying apparatus. The clothes drying apparatus can include a base portion with at least one blower. A drying chamber can be positioned above the base portion. A clothing frame can be housed within the drying chamber; the clothing frame having at least one vertical support member extending from the base portion, and at least one horizontal support frame member. A top portion can be removably coupled to the drying chamber.

### BACKGROUND

Drying clothes with a conventional clothes drying machine is well known. When utilizing a conventional dryer, clothes are typically spun, tossed and thrown around a drying bin at high temperatures. However, after a number of drying cycles clothes tend to shrink and become worn or discolored, among other things. Furthermore, certain articles of clothing, such as particularly delicate items, normally cannot be dried in this environment. These clothes must either be hung somewhere else, or taken to a costly dry cleaning shop where they are cleaned with harsh chemicals.

Additionally, conventional clothes dryers consume a large amount of energy and have large operating costs. An average household dryer can consume upwards of 6000 watts per hour, and can cost somewhere between $1 and $2 per hour to operate depending on the time of day and the rate of electricity. Furthermore, throughout the life of the dryer, the energy consumed and the operating costs often increase.

Moreover, conventional clothes dryers are large, heavy and generally immobile. Most clothes dryers take up a relatively large area in a home and are not easily moved within the home to create space. In addition, it is impractical to transport a conventional dryer for use in a location outside the home.

### SUMMARY

One exemplary embodiment of the invention describes a clothes drying apparatus. The clothes drying apparatus can include a base portion with at least one blower. A drying chamber can be positioned above the base portion. A clothing frame can be housed within the drying chamber; the clothing frame having at least one vertical support member extending from the base portion, and at least one horizontal support frame member. A top portion can be removably coupled to the drying chamber.

Another exemplary embodiment may include a method of drying clothes. The method includes steps for placing washed clothes into a drying chamber, sealing the drying chamber on all sides, and forcing air into the drying chamber from below utilizing at least one centrifugal blower.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 shows an exemplary embodiment of a clothes dryer.

FIG. 2 shows an exemplary embodiment of a clothing frame for a clothes dryer.

FIG. 3 shows another exemplary embodiment of a clothes dryer.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

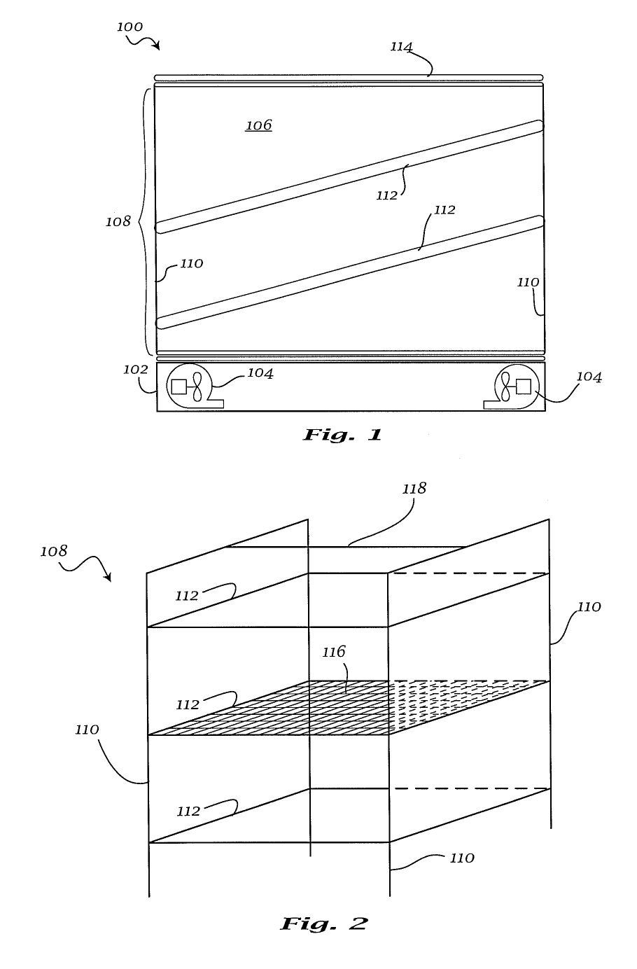

FIG. 1 shows an exemplary embodiment of a clothes dryer 100. Clothes dryer 100 may have a base portion 102. Base portion 102 may be made of any suitable material, for example, molded plastic. Base portion 102 may be any suitable size, for example, a two foot by two foot square. Alternatively, base portion may be sized and shaped in any suitable manner known to a person of ordinary skill in the art. Base portion 102 may also have a liner, which may collect excess moisture. The liner may be formed of any material desired, for example, an absorbent fabric.

At least one blower 104 may be disposed within base potion 102. Alternatively base portion 102 may have a plurality of blowers 104. Blowers 104 may be, for example, centrifugal blowers. The blowers 104 may be low volume, low speed blowers. For example, the blowers 104 may operate at about 100 to 200 cubic feet per minute (CFM) and may be powered by regular 120 volt household electricity. In other exemplary embodiments, blowers 104 may be powered in any manner, for example, by solar panels attached to the device. The blowers 104 may also be, for example, low discharge rate blowers. Blowers 104 may operate to force air from base portion 102 into drying chamber 106. Heat may not need to be applied. However, in another exemplary embodiment, blowers 104 may blow heated air. Blowers 104 may operate utilizing ambient air including, for example, inside or outside ambient air.

Clothes dryer 100 may have drying chamber 106. Drying Chamber 106 may be removably coupled to base portion 102. Alternatively drying chamber 106 and base portion 102 may be a single unit. Drying chamber 106 may be in fluid communication with base portion 102. Drying chamber 106 may be above base portion 102. Drying chamber 106 may be surrounded, wrapped or otherwise enclosed with a fire retardant material, for example a polyurethane or urethane coated nylon cloth, or any other decorative and/or functional material.

Drying chamber 106 may contain clothing frame 108. Clothing frame 108 may have at least one vertical support member 110 and least one horizontal support member 112. Alternatively, clothing frame 108 may have a plurality of vertical support members 110 and horizontal support members 112. Clothing frame 108 may also have at least one center bar disposed across horizontal support members 112. Center bar may operate, for example, to allow clothes to be hanged in drying chamber 106 while clothes machine 100 is in operation. Vertical support member 110 may extend from base portion 102. Horizontal support members 112 may be disposed at an angle to vertical support member 110. Horizontal support members 112 may have a removable wire mesh layer. The removable wire mesh layer may operate, for example, to allow clothes to be laid within drying chamber 106 while clothes machine 100 is in operation. Clothing frame 108 may be made of any suitable material known to a person of ordinary skill in the art. For example, clothing frame 108 may be made of a galvanized coil spring. Clothing frame 108 may be made of a collapsible material, or alternatively, may be made of a rigid material, for example, a hard plastic, wood, or other suitable material.

Clothes dryer 100 may have top portion 114. Top portion 114 may operate to seal drying chamber 106. Top portion 114 may be made of the same materials as drying chamber 106. Top portion 114 may be removably coupled to drying chamber 106 by any means known to a person of ordinary skill in the art. For example, top portion 114 may be hinged, clasped, clamped or otherwise coupled to drying chamber 106.

Referring generally to clothes dryer 100, clothes dryer 100 may be collapsible. For example clothes dryer 100 may be collapsed from a useable state into a smaller, portable state. Clothes dryer 100 may be collapsed in any manner, for example, using a lever, hinge or other means as desired. Alternatively, clothes dryer 100 may be rigid or may be stationary. Clothes dryer 100 may be customized to any suitable size known to a person of ordinary skill in the art. Clothes dryer 100 may be used inside or outside, and may further be transported to remote locations, for example, on a vacation. Clothes dryer 100 may further include a moisture sensor which may operate to shut clothes dryer 100 off once clothes in drying chamber 106 are dry. Clothes may be loaded into clothes dryer 100 via top portion 114. Alternatively clothes may be loaded into clothes dryer 100 by other means, for example, via a side or front door. Clothes dryer 100 may also have, for example, an energy usage module, power monitor, and watt/hour monitor.

Clothes dryer 100 may be an environmentally friendly apparatus that utilizes green technology. Clothes dryer 100 may utilize less energy than conventional clothes dryer, for example, the carbon footprint and green house emissions from clothes dryer 100 may be much smaller than conventional dryers as it may use significantly less power or energy than other known clothes dryers. Clothes dryer 100 may also operate at a much lower cost than traditional dryers.

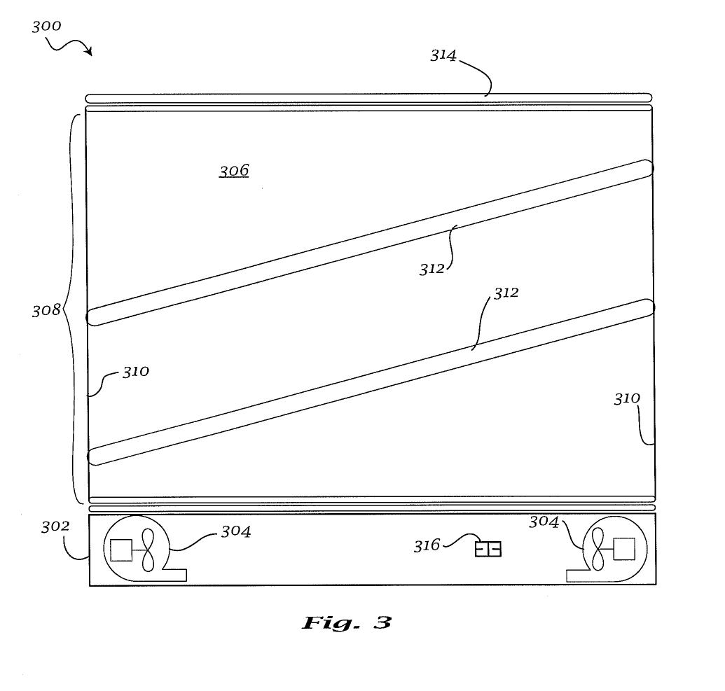

FIG. 2 shows an exemplary embodiment of clothing frame 108. Clothing frame 108 may be within drying chamber 106. Clothing frame 108 may have vertical support members 110 and horizontal support members 112. Clothing frame 108 may have removable wire mesh 116 that may couple to horizontal support members 112. Clothes may be placed across removable wire mesh 116. Clothes dryer 100 may also have at least one center bar 118. Alternatively, clothes dryer 100 may a have a plurality of center bars. Clothes may be hung from center bar 118, for example, by a clothes hanger during operation of clothes dryer 100.

FIG. 3 shows another exemplary embodiment of clothes dryer 300 Clothes dryer 300 may have a base portion 302. Base portion 302 may be made of any suitable material, for example, molded plastic. Base portion 302 may be any suitable size, for example, an about three foot by three foot square, and may have a height, for example, about eight inches. Alternatively base portion may be sized and shaped in any suitable manner known to a person of ordinary skill in the art. Control switch 316 may be disposed on base portion 302.

A plurality of centrifugal blowers 304 may be disposed within base potion 302. The centrifugal blowers 304 may be low volume, low speed blowers. For example, the blowers 304 may operate at about 100 to 200 cubic feet per minute (CFM) and may be powered by regular 120 volt household electricity. In other exemplary embodiments, blowers 104 may be powered in any manner, for example, by solar panels or other green technology attached to the device. In some exemplary embodiments, solar panels may be coupled to any portion of clothes dryer 300, for example exterior portions. The blowers 304 may also be, for example, low discharge rate blowers. Blowers 304 may operate to force air from base portion 302 into drying chamber 306. Heat may not need to be applied. Blowers 304 may operate utilizing ambient air including, for example, inside or outside ambient air.

Clothes dryer 300 may have drying chamber 306. Drying Chamber 306 may be removably coupled to base portion 302. Alternatively drying chamber 306 and base portion 302 may be a single unit. Drying chamber 306 may be in fluid communication with base portion 302. Drying chamber 306 may be above base portion 302. Drying chamber 306 may be surrounded, wrapped or otherwise enclosed with a fire retardant material, for example a polyurethane or urethane coated nylon cloth. Drying chamber 306 may be any suitable size. For example, drying chamber 306 may have a length of about three feet, a height of about three feet and a width of about three feet.

Drying chamber 306 may contain clothing frame 308. Clothing frame 308 may have vertical support member 310 and one or more horizontal support members 312. Vertical support member 310 may extend from base portion 302. Horizontal support members 312 may be disposed at an angle to vertical support member 310. Horizontal support members 312 may have a removable wire mesh layer similar to that described earlier. The removable wire mesh layer may operate, for example, to allow clothes to be laid within drying chamber 306 while clothes machine 300 is in operation. Clothing frame 308 may be made of any suitable material known to a person of ordinary skill in the art. For example, clothing frame 308 may be made of a galvanized coil spring. Clothing frame 308 may be collapsible. When collapsed, the dimensions of clothes dryer 300 may be reduced. For example, clothes dryer may have a length of about two feet, a width of about two feet and a height of about fifteen inches when collapsed. Clothes dryer 300 may be stored, for example, in a carrying case.

Clothes dryer 300 may have top portion 314. Top portion 314 may operate to seal drying chamber 306. Top portion 314 may be made of the same materials as drying chamber 306. Top portion 314 may be removably coupled to drying chamber 306 by any means known to a person of ordinary skill in the art. For example, top portion 314 may be hinged, clasped, clamped or otherwise coupled to drying chamber 306.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A clothes drying apparatus comprising:
a base portion with at least one blower;
a drying chamber above the base portion;
a clothing frame within the drying chamber, the clothing frame having at least one vertical support member extending from the base portion, and at least one horizontal support frame member; and
a top portion removably coupled to the drying chamber.

2. The clothes drying apparatus of claim 1, wherein the base portion is in fluid communication with the dying chamber.

3. The clothes drying apparatus of claim 1, wherein the at least one blower is a centrifugal blower.

4. The clothes drying apparatus of claim 3, wherein the at least one blower is a low volume, low speed centrifugal blower.

5. The clothes drying apparatus of claim 1, wherein the at least one horizontal support frame member is disposed at an angle to the at least one vertical support member.

6. The clothes drying apparatus of claim 1, wherein the at least one horizontal support frame member has a removable wire mesh layer.

7. The clothes drying apparatus of claim 1, wherein the at least one horizontal support frame member has at least one center bar.

8. The clothes drying apparatus of claim 1, wherein the base portion is molded plastic.

9. The clothes drying apparatus of claim 1, wherein the clothing frame is made of a galvanized coil spring.

10. The clothes drying apparatus of claim 1, wherein the drying chamber is wrapped with a fire retardant material.

11. The clothes drying apparatus of claim 1, wherein the clothes drying apparatus is collapsible.

12. The clothes drying apparatus of claim 1, wherein the clothes drying apparatus is portable.

13. The clothes drying apparatus of claim 1, wherein the base portion includes a liner.

14. The clothes drying apparatus of claim 1, further comprising:
a moisture sensor proximate the top chamber

15. A method of drying clothes comprising:
placing washed clothes into a drying chamber;
sealing the drying chamber on all sides;
forcing air into the drying chamber from below utilizing at least one centrifugal blower.

16. The method of claim 15 further comprising:
hanging the washed clothes in the drying chamber.

17. The method of claim 15 further comprising:
placing the washed clothes on at least one removable shelf with the drying chamber.

18. The method of claim 15 further comprising:
utilizing inside or outside ambient air to force air into the drying chamber.

19. The method of claim 15 further comprising:
forcing air into the drying chamber at a low rate.

20. The method of claim 15 further comprising:
sensing that the clothes in the drying chamber are dry and automatically shutting the at least one centrifugal blower off.
